(19) United States
(12) Patent Application Publication
(10) Pub. No.: US 2018/0226214 A1
(43) Pub. Date: Aug. 9, 2018

(54) Gas Breaker

(71) Applicant: Hitachi, Ltd., Tokyo (JP)

(72) Inventors: Hideyuki KOTSUJI, Tokyo (JP); Hajime URAI, Tokyo (JP); Masanao TERADA, Tokyo (JP); Makoto HIROSE, Tokyo (JP)

(21) Appl. No.: 15/855,170

(22) Filed: Dec. 27, 2017

(30) Foreign Application Priority Data
Jan. 13, 2017 (JP) 2017-003776

(51) Int. Cl. H01H 33/88; H01H 33/56

(52) U.S. Cl. CPC H01H 33/88; H01H 33/56

(57) ABSTRACT

There is provided a gas circuit breaker that includes: a puffer shaft connected to one of a pair of arcing contacts, a puffer cylinder that is coaxially provided on an outer circumference of the puffer shaft, an insulating nozzle that is fixed to the puffer cylinder on a breaker side, an insulating rod that connects the puffer shaft and an operating device to each other, a shaft guide that is provided on an outer circumference of the puffer shaft and the insulating rod, and an exhaust guide that is provided on an outer circumference of the shaft guide, in which hot gas is discharged into a gas tank through a shaft exhaust hole of the puffer shaft, between the puffer shaft and the shaft guide, and a conductor exhaust hole of a movable side exhaust conductor in the middle of interrupting operation, the shaft exhaust hole of the puffer shaft communicates with a shaft guide exhaust hole of the shaft guide in a region near a current zero point before the termination of the interrupting operation, and thus an exhaust flow path changes.

### BACKGROUND OF THE INVENTION

### 1. Field of the Invention

The present invention relates to a breaker, and more particularly to a gas circuit breaker that blows insulating gas at the time of shutting off a current to extinguish an arc.

### 2. Background Art

As an exhaust structure for cooling generated hot gas, there is an invention described in JP-A-2000-268688. The present invention is a structure in which a cooling blade for changing the flow of exhausted gas is arranged between a movable side puffer shaft and a movable side exhaust conductor. The exhausted hot gas hits the cooling blade, stirring with the surrounding low-temperature gas is promoted, and the high-temperature gas is cooled. By cooling the high-temperature gas discharged from an exhaust pipe, insulation performance against the ground of the breaker is improved.

In the invention described in JP-A-2000-268688, since the cooling blade is arranged between the movable side puffer shaft and the movable side exhaust conductor, for an exhaust structure on the movable side, there is a problem that flow path resistance of the exhausted gas always becomes large, hindering exhausting of the hot gas between electrodes and reducing interrupting performance between the electrodes.

### SUMMARY OF THE INVENTION

According to an aspect of the present invention, there is provided a gas circuit breaker including a pair of arcing contacts that is arranged oppositely to each other to be opened and closed in a gas tank and a puffer shaft that is coaxially connected to one of the pair of arcing contacts and includes a shaft exhaust hole in a circumferential direction thereof, a puffer cylinder that is coaxially provided on an outer circumference of the puffer shaft, a puffer piston that is provided in a space between the puffer cylinder and the puffer shaft, an insulating nozzle that is fixed to the puffer cylinder on a breaker side, an insulating rod that connects the puffer shaft and an operating device to each other, a shaft guide that is provided on an outer circumference of a connection portion between the puffer shaft and the insulating rod and includes a shaft guide exhaust hole in a circumferential direction thereof, an exhaust guide that is provided on an outer circumference of the shaft guide, and a movable side exhaust conductor that is supported on an inner wall of the gas tank with a supporting insulator on an outer circumference of the exhaust guide and includes a conductor exhaust hole on an outer circumference thereof, in which the gas circuit breaker has a first mode in which hot gas generated by interrupting operation is discharged into the gas tank through the shaft exhaust hole of the puffer shaft, the space formed by the puffer shaft and the shaft guide, and the conductor exhaust hole of the movable side exhaust conductor in the middle of interrupting operation and a second mode in which the shaft exhaust hole of the puffer shaft communicates with the shaft guide exhaust hole of the shaft guide, and hot gas is exhausted into the gas tank through the conductor exhaust hole of the movable side exhaust conductor.

In the aspect of the present invention, by discharging the hot gas generated between the electrodes in the middle of interrupting operation into the gas tank through the shaft exhaust hole of the puffer shaft, the space formed by the puffer shaft and the shaft guide, and the flow path of the movable side exhaust conductor and the conductor exhaust hole thereof, when the hot gas is exhausted into the gas tank, the gas may be cooled, and the insulation performance may be improved. In addition, by connecting the shaft exhaust hole of the puffer shaft and the shaft guide exhaust hole of the shaft guide to the region near the current zero point before the termination of the interrupting operation, the exhaust flow path is shortened, the resistance of the exhaust flow path is reduced, the gas between the electrodes is efficiently exhausted, and the interrupting performance between the electrodes may be improved.

### BRIEF DESCRIPTION OF THE DRAWINGS

FIG. 1 is a sectional view of a gas circuit breaker.

FIG. 2 is an explanatory view of a gas flow of hot gas from a puffer shaft in the gas circuit breaker.

FIG. 3 is a cross-sectional view of the gas circuit breaker according to Example 1 in the middle of interrupting operation.

FIG. 4 is an enlarged cross-sectional view for explaining an exhaust flow path of the hot gas in the gas circuit breaker according to Example 1 in the middle of the interrupting operation.

FIG. 5 is a cross-sectional view of the gas circuit breaker according to Example 1 before termination of the interrupting operation.

FIG. 6 is an enlarged cross-sectional view for explaining the exhaust flow path of the hot gas before the termination of the interrupting operation of the gas circuit breaker according to Example 1.

FIG. 7 is a cross-sectional view showing a positional relationship between a shaft exhaust hole of a puffer shaft, a shaft guide exhaust hole of a shaft guide, and an exhaust hole of a conductor exhaust hole of a movable side conductor before the termination of the interrupting operation of the gas circuit breaker according to Example 1.

FIG. 8 is an explanatory view showing a region A in which a interrupting current flowing in the gas circuit breaker is in the middle of the interrupting operation and a region B in which the interrupting current toward a current zero point beyond a current peak of a last half wave becomes small.

### DETAILED DESCRIPTION OF THE INVENTION

Hereinafter, an example of the present invention will be described with reference to drawings. The following is merely an example of implementation, and it is not intended to limit the content of the invention to the following specific aspects. The invention itself may be implemented in various modes as long as the invention conforms to the contents described in the claims.

### Example 1

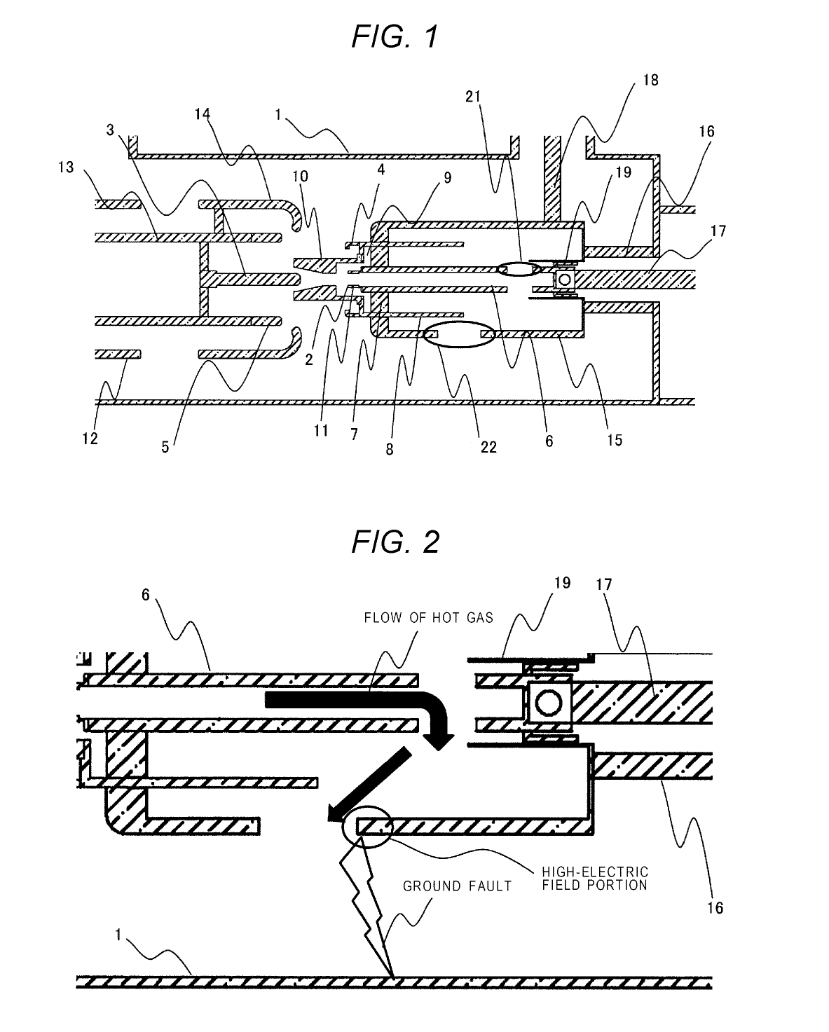

The outline structure and operation of a gas circuit breaker at the time of interrupting operation will be described with reference to FIG. 1. The gas circuit breaker is housed in a gas tank 1 filled with insulating gas. Although omitted in FIG. 1, the breaker is connected to an operating device (not shown) through a puffer shaft 6 via an insulating rod 17, and the entire breaker is arranged in the gas tank 1 filled with SF6 gas. As shown in FIG. 1, the breaker is constituted by a fixed side arcing contact 3 and a movable side arcing contact 2, a puffer cylinder 8, a puffer chamber 9 constituted by a space surrounded by the puffer cylinder 8, a puffer piston 7, the puffer shaft 6, a contact cover 11, and an insulating nozzle 10, a movable side main contact 4, a fixed side main contact 5, a conductor 18, a shield 14, a shaft guide 19, and a movable side exhaust conductor 15.

A fixed side conductor 12 and a fixed side exhaust pipe 13 are electrically connected to the fixed side arcing contact 3 through a metal supporting structure, and the movable side arcing contact 2, the puffer shaft 6, the puffer piston 7, the puffer cylinder 8, and the movable side main contact 4 electrically connected to one another are electrically connected to the fixed side in an energized state (closed state) respectively. The puffer chamber 9 is arranged coaxially on the inner periphery of the puffer cylinder 8 with the puffer cylinder 8, the inside of the puffer chamber 9 is hollow, and the puffer shaft 6 into which the insulating gas flows and the puffer piston 7 sliding in a space formed between the puffer cylinder 8 and the puffer shaft 6 are formed in the hollow space.

The interrupting portion on the operating device side is fixed to a mounting seat provided on the inner circumferential surface of the gas tank 1 by a supporting insulator 16.

Normally, the fixed side arcing contact 3 on the side opposite to the movable side arcing contact 2 on the operating device side, and the fixed side main contact 5 and the movable side main contact 4 are electrically connected, but when a command of opening electrodes is transmitted at the time of an accident, the movable side is operated by the operating device (not shown) via the puffer shaft 6 and the insulating rod 17, and the fixed side arcing contact 3 on the fixed side and the movable side arcing contact 2 on the movable side, and the fixed side main contact 5 and the movable side main contact 4 are physically separated from each other.

Even after the contact is released, an electric current flows between the fixed side arcing contact 3 and the movable side arcing contact 2, and an arc is generated. Since the gas circuit breaker blows high-pressure insulating gas on the arc to extinguish the arc, the insulating gas in the puffer chamber 9 is compressed by the puffer piston 7 at the time of operation of the movable side, the gas is blown to the arc, and the arc is extinguished.

Pressure formation in the puffer chamber 9 in which insulating gas is blown to the arc is performed by the movable puffer cylinder 8 moving relative to the fixed puffer piston 7. More specifically, the driving force of the operating device is transmitted from the insulating rod 17 connected to the operating device (not shown) to the puffer cylinder 8 through the puffer shaft 6, and the insulating gas in the puffer chamber 9 is compressed by the puffer cylinder 8 moving to the right side of the drawing.

The high-pressure insulating gas compressed in the puffer chamber 9 is blown against the generated arc between the fixed side arcing contact 3 and the movable side arcing contact 2 during the interrupting operation. The high-temperature hot gas generated after being blown to the arc is discharged to the fixed side and the operating device side respectively, passes through the inside of the insulating nozzle 10 and the fixed side exhaust pipe 13 on the fixed side, and is discharged into the gas tank 1 while being cooled.

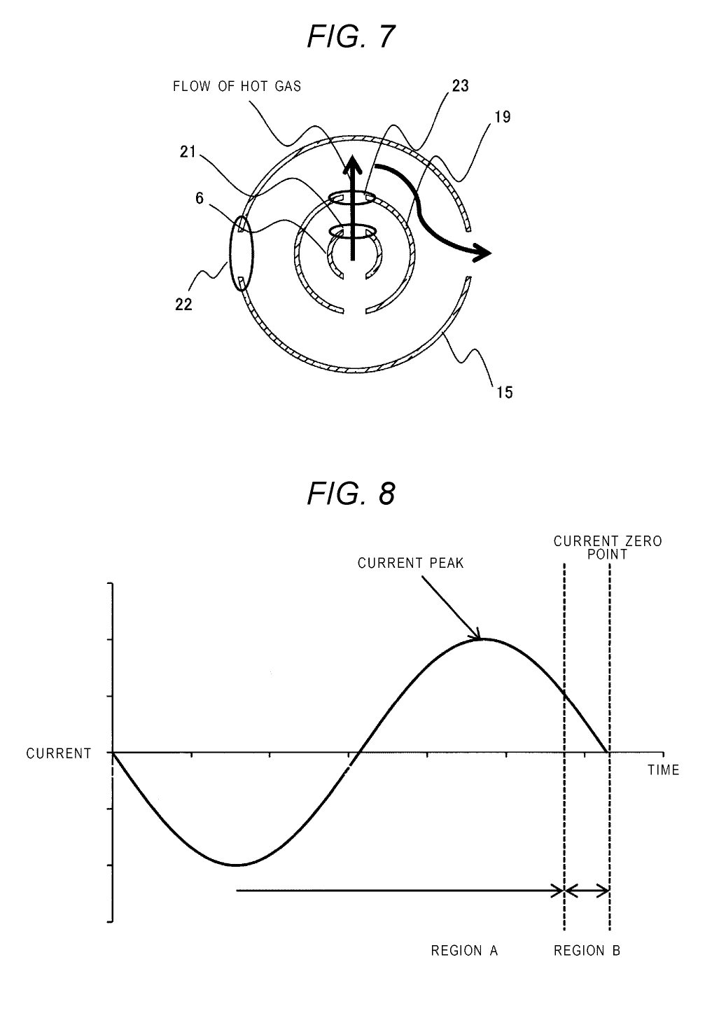

On the operating device side, the high-temperature hot gas is discharged to the movable side exhaust conductor 15 through a shaft exhaust hole 21 of the puffer shaft 6 and then discharged into the gas tank 1 through a conductor exhaust hole 22 of the movable side exhaust conductor 15. In FIGS. 1 to 6, the conductor exhaust hole is shown in the same sectional view because the positional relationship becomes easy to understand, but actually the positional relationship shown in FIG. 7 is obtained.

The density of the hot gas generated at the time of gas blowing is low because the temperature thereof is high and thus the dielectric strength thereof is low. In order to prevent deterioration of insulation performance between the electrodes, it is necessary to discharge the hot gas promptly after the arc extinguishing succeeds, and the hot gas is exhausted to the fixed side and the movable side through the insulating nozzle 10 and the puffer shaft 6 respectively.

The role of the cylinder is to discharge the generated hot gas promptly without staying between the electrodes and to efficiently cool the hot gas.

The mechanism of dielectric breakdown generation between the movable side exhaust conductor 15 and the gas tank 1 will be described with reference to FIG. 2. When the hot gas whose density remains low because of insufficient cooling of the gas and which is high in temperature and low in dielectric strength reaches a high-electric field portion at the end of the conductor exhaust hole 22 of the movable side exhaust conductor 15, the dielectric strength between the movable side exhaust conductor 15 and the gas tank 1 decreases, and there is a possibility of occurrence of an accident (ground fault) which causes dielectric breakdown between the movable side exhaust conductor 15 and the gas tank 1.

For a ground fault accident, means for obtaining the insulation performance against the ground by electric field relaxation between the movable side exhaust conductor 15 and the gas tank 1 by expanding the diameter of the gas tank, and means for improving the cooling capability of the hot gas by enlarging the exhaust pipe are taken. However, such means leads to enlargement of the breaker structure and the exhaust/shield structure. In addition, in recent years, a high-voltage and large-volume current of an electric power system is being developed, and the capacity of a gas circuit breaker is being increased to obtain a required interrupting performance, but contrary to this development, in order to reduce the cost, miniaturization of the gas circuit breaker by optimizing the structure of the breaker and the structure of an exhaust/shield is also under way.

FIG. 8 is an explanatory view showing a region A in which a interrupting current flowing in the gas circuit breaker is in the middle of interrupting operation and a region B in which the interrupting current toward a current zero point beyond a current peak of a last half wave becomes small. In the region A, the arc energy increases, the temperature of the hot gas to be exhausted is also high, and the flow velocity is also fast. In the region B, the current peak is passed, and the arc energy becomes small, thus the temperature of the gas generated also decreases and the flow velocity also decreases. At the current zero point, it is also necessary to exhaust the hot gas between the electrodes sufficiently to withstand the recovery voltage applied between the electrodes.

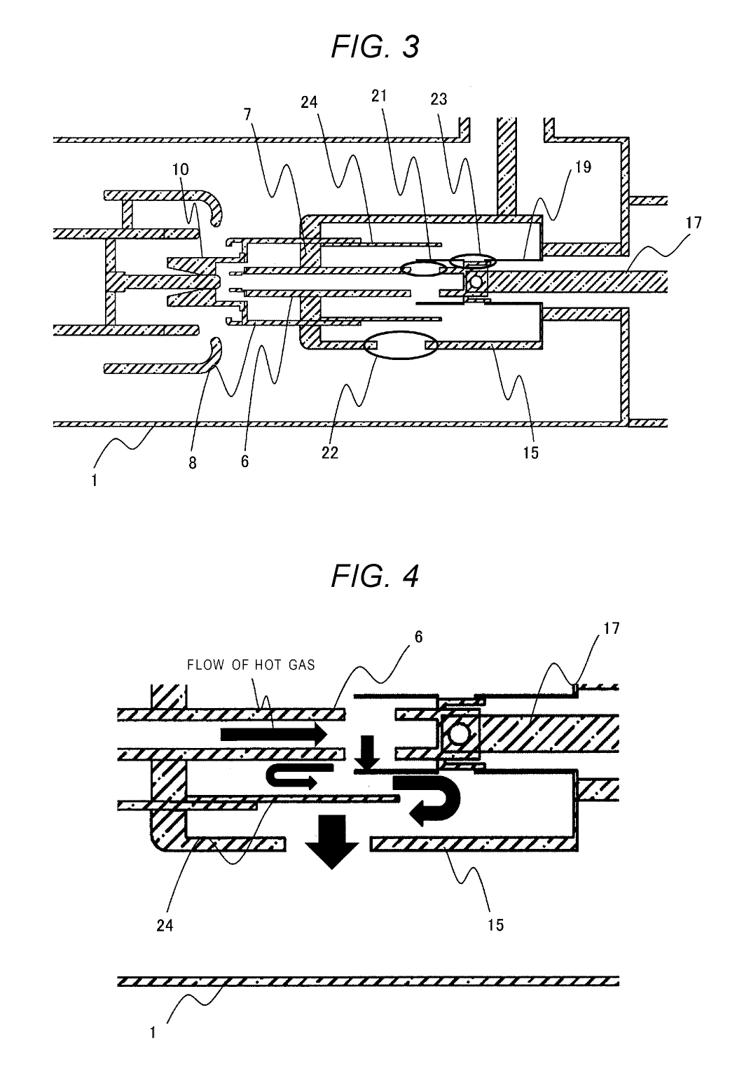

In FIG. 3, the exhaust flow path of the hot gas in the middle of the interrupting operation in Example 1 will be described. Description of parts similar to those in FIG. 1 will be omitted. The shaft guide 19 is extended to the fixed side as described in the sectional view in the middle of the interrupting operation of FIG. 3, and the shaft guide 19 including a shaft guide exhaust hole 23 in the circumferential direction and an exhaust guide 24 located on the concentric outer circumference of the shaft guide 19 are fixedly installed on the operating device side of the puffer piston 7. As described in the enlarged sectional view of the exhaust flow path of hot gas in the middle of the interrupting operation of FIG. 4, the hot gas generated between the electrodes is discharged from the shaft exhaust hole 21 of the puffer shaft 6 and flows into the space formed by the puffer shaft 6 and the shaft guide 19. Thereafter, the hot gas is exhausted into the movable side exhaust conductor 15 through the flow path formed by the shaft guide 19 and the exhaust guide 24 and exhausted into the gas tank 1 through the conductor exhaust hole 22.

The hot gas having a rapid flow generated during the interrupting operation is cooled while passing through the flow path formed by the shaft guide 19 and the exhaust guide 24 and has a temperature having sufficient insulation performance when the hot gas reaches the high electric field portion of the conductor exhaust hole 22.

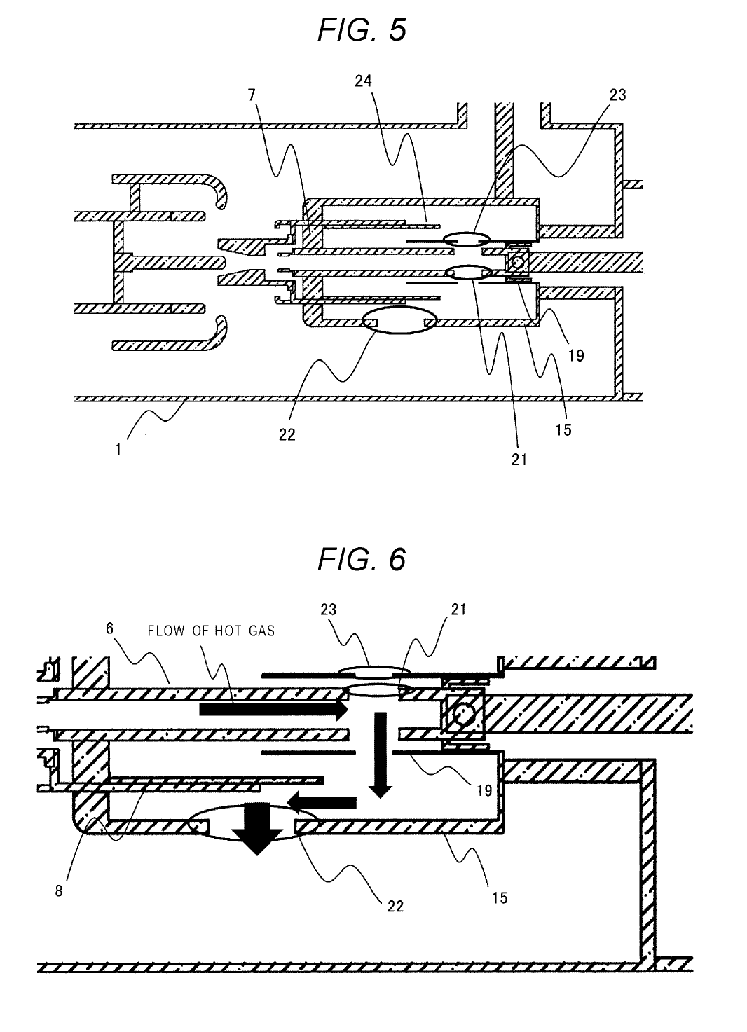

Next, the gas flow path immediately before the termination of the interrupting operation will be explained with reference to FIG. 5 and FIG. 6. FIG. 5 is a sectional view of the gas circuit breaker before termination of the interrupting operation and shows the positional relationship of the interrupting portion. FIG. 6 is an enlarged sectional view for explaining the exhaust flow path of the hot gas before the termination of the interrupting operation and an enlarged sectional view around the movable side exhaust conductor 15. As shown in FIG. 6, the shaft exhaust hole 21 communicates with the shaft guide exhaust hole 23 and has a positional relationship where the hot gas is exhausted directly to the movable side exhaust conductor 15. The flow path up to the conductor exhaust hole 22 becomes shorter than the flow path in the middle of the interrupting operation shown in FIG. 4, and the flow path resistance becomes small. Therefore, the current peak is passed, the arc energy becomes small, and the hot gas whose flow velocity has been slowed may also be sufficiently exhausted between the electrodes, thereby preventing deterioration in inter-electrode performance.

FIG. 7 is a sectional view showing the positional relationship between the shaft exhaust hole 21 of the puffer shaft, the shaft guide exhaust hole 23 of the shaft guide, and the exhaust hole of the conductor exhaust hole 22 of the movable side conductor before termination of the interrupting operation of the gas circuit breaker.

As shown in FIG. 7, the shaft exhaust hole 21 communicates with the shaft guide exhaust hole 23 in the upward and downward direction of the drawing, and the conductor exhaust hole 22 is arranged in the lateral direction which is different by 90 degrees. By arranging the holes alternately at 90 degrees like this, the hot gas coming out from the shaft exhaust hole 21 and the shaft guide exhaust hole 23 may hit against the inner wall of the movable side exhaust conductor 15 and may be exhausted into the gas tank 1 through the conductor exhaust hole 22. Compared with the case of directly exhausting to the conductor exhaust hole 22, by bypassing the inside of the movable side exhaust conductor 15, a cooling effect of the hot gas may be obtained.

In the above example, there are two shaft exhaust holes 21 and two shaft guide exhaust holes 23 in the case of being opened in the upward and downward direction of the drawing, but even when the number of holes is changed, the same cooling effect may be obtained by arranging the exhaust holes alternately in a similar manner in the circumferential direction.

In the above example, a puffer-type breaker which obtains blowing gas pressure by mechanical compression of the puffer piston 7 is described, but it is also possible to apply the present invention to a heat puffer-type breaker which is provided with a volume-fixed heat puffer chamber and obtains blowing gas pressure by taking in arc heat.

SF6 is used as insulating gas in the present example, but the type of insulating gas is not limited to SF6, but other insulating gas such as dry air/nitrogen gas may be used.

As described above, according to the present example, by discharging the hot gas generated between the electrodes in the middle of interrupting operation into the gas tank through the shaft exhaust hole of the puffer shaft, the space formed by the puffer shaft and the shaft guide, and the flow path of the movable side exhaust conductor and the conductor exhaust hole thereof, when the hot gas is exhausted into the gas tank, the gas is cooled, and the insulation performance is improved. In addition, by connecting the shaft exhaust hole of the puffer shaft and the shaft guide exhaust hole of the shaft guide to the region near the current zero point before the termination of the interrupting operation, the exhaust flow path is shortened, the resistance of the exhaust flow path is reduced, the gas between the electrodes is efficiently exhausted, and the interrupting performance between the electrodes may be improved.

1. A gas circuit breaker comprising:
a pair of arcing contacts that is arranged oppositely to each other to be opened and closed in a gas tank; and
a puffer shaft that is coaxially connected to one of the pair of arcing contacts and includes a shaft exhaust hole in a circumferential direction thereof;
a puffer cylinder that is coaxially provided on an outer circumference of the puffer shaft;
a puffer piston that is provided in a space between the puffer cylinder and the puffer shaft;
an insulating nozzle that is fixed to the puffer cylinder on a breaker side;
an insulating rod that connects the puffer shaft and an operating device to each other;
a shaft guide that is provided on an outer circumference of a connection portion between the puffer shaft and the insulating rod and includes a shaft guide exhaust hole in a circumferential direction thereof;
an exhaust guide that is provided on an outer circumference of the shaft guide; and
a movable side exhaust conductor that is supported on an inner wall of the gas tank with a supporting insulator on an outer circumference of the exhaust guide and includes a conductor exhaust hole on an outer circumference thereof,
wherein the gas circuit breaker has a first mode in which hot gas generated by interrupting operation is discharged into the gas tank through the shaft exhaust hole of the puffer shaft, the space formed by the puffer shaft and the shaft guide, and the conductor exhaust hole of the movable side exhaust conductor in the middle of the interrupting operation, and a second mode in which the shaft exhaust hole of the puffer shaft communicates with the shaft guide exhaust hole of the shaft guide, and hot gas is exhausted into the gas tank through the conductor exhaust hole of the movable side exhaust conductor.

2. The gas circuit breaker according to claim 1,
wherein in a region at the time of starting the interrupting operation, the first mode is realized, and in a region near a current zero point before the termination of the interrupting operation, the second mode is realized, and thus an exhaust flow path changes.

3. The gas circuit breaker according to claim 1,
wherein the shaft exhaust hole of the puffer shaft and the shaft guide exhaust hole of the shaft guide are arranged alternately with the conductor exhaust hole of the movable side exhaust conductor in the circumferential direction.
